(19) United States
(12) Patent Application Publication
(10) Pub. No.: US 2015/0026563 A1
(43) Pub. Date: Jan. 22, 2015

(54) EVALUATION DEVICE, EVALUATION METHOD, EVALUATION PROGRAM, AND COMPUTER-READABLE RECORDING MEDIUM RECORDING EVALUATION PROGRAM

(71) Applicant: Rakuten, Inc., Shinagawa-ku, Tokyo (JP)

(72) Inventor: Kazuhiro Tomoda, Shinagawa-ku (JP)

(73) Assignee: RAKUTEN, INC., Shinagawa-ku, Tokyo (JP)

(21) Appl. No.: 14/381,820

(22) PCT Filed: Jan. 30, 2013
(86) PCT No.: PCT/JP2013/052072

§ 371 Date: Aug. 28, 2014

(30) Foreign Application Priority Data
Feb. 29, 2012 (JP) 2012-044275

(51) Int. Cl. G06F 17/22; G06F 17/21

(52) U.S. Cl. CPC G06F 17/2247; G06F 17/217
USPC 715/234

(57) ABSTRACT

Provided are an evaluation device, an evaluation method, and an evaluation program for further accurately evaluating the magnitude of effect of each page in an electronic book on getting users interested, and also a computer-readable recording medium recording the program. With a book server 100, a start page is identified first and a display amount of each page is counted. The display amount counted is weighted for each page by using weight coefficients determined by a coefficient storage unit 2. For page 7 displayed five times, the display amount is weighted with 1.6, 1.6, 0.9, 1.1, and 0.9 for the respective times. The total amount of the display amount of each page thus weighted is calculated. For page 7, the total amount of the display amount for each page is calculated as 6.1 points.

### TECHNICAL FIELD

The present invention relates to an evaluation device, an evaluation method implemented by the evaluation device, an evaluation program that causes a computer to function as the evaluation device, and a computer-readable recording medium for storing the program.

### BACKGROUND ART

Conventionally, methods for measuring the magnitude of effect of each content in a web page on getting users as readers interested (the degree of contribution to the success in getting the users interested or causing the users to purchase the content) have been provided. Contents published on a web page are given approximately equal opportunities to be selected and browsed by users.

Patent Literature 1 discloses an information processing apparatus that retrieves the time spent for reading per page and the number of pages turned over by a user, for example, for each page in an electronic book and that disables browsing of the electronic book when these retrieved items do not satisfy predetermined conditions.

### CITATION LIST

### Patent Literature

[Patent Literature 1] Japanese Patent Application Laid-Open Publication No. 2003-150772

### SUMMARY OF INVENTION

### Technical Problem

Providers of electronic books such as e-books have a desire to count the number of browsed pages and, when an electronic book is purchased, grasp which browsed page (corresponding to the content in the web page) has contributed to the purchase.

However, when browsing an ordinary electronic book to determine whether to purchase it, reading opportunities are not equal among pages under the constraint that the book has to be read from the first page in order. This causes page views of the first page that is a starting point of a direction in which pages are turned over to be counted many times when the number of pages, for example, is simply counted.

Accordingly, when the degree of contribution described above is measured after the electronic book is purchased, the degree of contribution of a page closer to the first page is more likely to be determined higher than that of a page further apart from the first page. This reduces the accuracy of measuring the degree of contribution described above.

The present invention has been made to solve the above-described problem and aims to provide an evaluation device, an evaluation method, and an evaluation program for further accurately evaluating the magnitude of effect of each page in an electronic book on getting users interested, and also a computer-readable recording medium recording the program.

### Solution to Problem

According to one aspect of the present invention, an evaluation device includes start page identification means for identifying a start page that is initially displayed by a user terminal in an electronic book having a plurality of pages; coefficient determination means for, when another page of the electronic book is displayed subsequently to the start page identified as the starting point by the start page identification means, determining a weight coefficient for each page displayed so that the weight coefficient increases with more pages apart from the start page; counting means for counting a display amount of each page; computing means for performing computation for weighting the display amount counted by the counting means for each page, using the weight coefficient determined by the coefficient determination means; and calculating means for performing computation for calculating the total amount of the display amount weighted by the computing means for each page.

The evaluation device according to the one aspect of the present invention identifies the start page first and counts the display amount of each page. Next, the evaluation device determines the weight coefficient for each page so that the weight coefficient increases with more pages apart from the start page, weights the display amount thus counted for each page, and calculates the total amount of the display amount thus weighted for each page. In this manner, the display amount counted is weighted for each page by using the weight coefficient that increases with more pages apart from the start page. Accordingly, by weighting each page so that the weight coefficient increases with more pages apart from the start page instead of simply determining that the above-described degree of contribution of a page closer to the first page whose page views are more likely to be counted more is higher than that of a page further apart from the first page, it is possible to more accurately evaluate the magnitude of effect of each page in the electronic book on getting users interested.

According to another aspect, in the evaluation device, the display amount is the number of display times each page is displayed by the user terminal.

In this aspect, by using the weight coefficient determined by the coefficient determination means, the number of display times counted in each display direction is weighted for each page in each display direction. Accordingly, it is possible to more accurately evaluate the magnitude of effect of each page in the electronic book on getting the user interested without determining that the above-described degree of contribution of a page closer to the first page is higher than that of a page further apart from the first page.

According to another aspect, in the evaluation device, the display amount is a period of display time during which each page is displayed by the user terminal.

In this aspect, by using the weight coefficient determined by the coefficient determination means, the period of display time counted in each display direction is weighted for each page in each display direction. Accordingly, it is possible to more accurately evaluate the magnitude of effect of each page in the electronic book on getting the user interested without determining that the above-described degree of contribution of a page closer to the first page is higher than that of a page further apart from the first page.

According to another aspect, in the evaluation device, the start page identification means identifies the start page and, when another page in the electronic book is displayed subsequently to the start page as the starting point, identifies a display direction indicating whether these pages are displayed in the direction in which page numbers increase or displayed in the direction in which page numbers decrease; the coefficient determination means determines the weight coefficient for each page in each display direction identified by the start page identification means; the counting means counts the display amount for each page in each display direction; and the computing means weights the display amount counted by the counting means for each page in each display direction, using the weight coefficient determined by the coefficient determination means.

In this aspect, when another page is displayed subsequently to the start page as the starting point, the display direction of the pages is identified, and the weight coefficient for each page in each display direction thus identified is determined. Furthermore, the display amount for each page in each display direction is counted, and the display amount counted in each display direction is weighted for each page in each display direction. Accordingly, the weight coefficient for each page in each display direction identified is determined, and the display amount counted in each display direction is thereby weighted, whereby it is possible to more accurately evaluate the magnitude of effect of each page in the electronic book on getting users interested.

According to another aspect, in the evaluation device, the start page identification means identifies a turned-back page at a turned-back position when the display direction is changed, and the coefficient determination means determines the weight coefficient for each page displayed based on the start page, the display direction, and the turned-back page identified by the start page identification means.

In this aspect, the turned-back page at a turned-back position when the display direction is changed is identified, and the weight coefficient for each page displayed is determined based on the start page, the display direction, and the turned-back page. Accordingly, even when the display direction is changed, a coefficient determined based on the turned-back page is used, whereby it is possible to more accurately evaluate the magnitude of effect for each page in the electronic book on getting users interested.

According to another aspect, in the evaluation device, the counting means counts the display amount of the turned-back page with a predetermined amount added when the display direction is changed.

In this aspect, it is possible to count the display amount of the turned-back page with a predetermined amount added when the display direction is changed.

According to another aspect, the evaluation device further includes content determination means for determining whether a content-containing page containing a plurality of contents exists among the pages; and total amount distribution means for, when the content determination means determines that the content-containing page exists, performing computation for distributing the total amount of the display amount of each page calculated by the calculating means in accordance with occupying rates of the respective contents in the content-containing page.

In this aspect, when it is determined that a content-containing page exists, computation for distributing the total amount of the display amount of each page in accordance with occupying rates of the respective contents in the content-containing page is performed. This makes it possible to more accurately evaluate the magnitude of effect of the respective contents on getting users interested.

According to another aspect, the evaluation device further includes writer storage means for storing the respective contents and writer information on respective writers of the contents in association with each other, and sales distribution means for performing computation for distributing sales figures of the electronic book in accordance with amounts of contents created by the respective writers that are indicated by the writer information stored in the writer storage means.

In this aspect, computation for distributing the sales figures of the electronic book in accordance with the amounts of contents created by the respective writers indicated by the writer information is performed. This makes it possible to distribute the sales figures to the respective writers of the contents in accordance with the amount of content created.

According to another aspect, the evaluation device further includes changing means for changing the start page to be initially displayed by the user terminal to a page selected at random.

In this aspect, it is possible to change the start page to be initially displayed by the user terminal to a page selected at random.

According to another aspect, in the evaluation device, the changing means changes the start page to be initially displayed by the user terminal to a page selected at random when a predetermined condition is satisfied.

In this aspect, when the predetermined condition is satisfied, it is possible to change the start page to be initially displayed by the user terminal to a page selected at random.

According to another aspect, in the evaluation device, the changing means changes display order at random for another page to be displayed subsequently to the start page.

In this aspect, it is possible to change display order at random for another page displayed subsequently to the start page.

According to another aspect, the evaluation device further includes final identification means for identifying a finally displayed page that is finally displayed by the user terminal in the electronic book when a purchase process for purchasing the electronic book is performed; and page identification means for identifying the finally displayed page identified by the final identification means as an already-read middle page that is a page in the middle of displayable pages and is displayed for the second time or later for the user, as a first-time middle page that is a page in the middle of displayable pages and is displayed for the first time for the user, or as a first-time end page that is the last page of displayable pages and is displayed for the first time for the user. The weight coefficient determined by the coefficient determination means decreases in the order of the already-read middle page, the first-time middle page, and the first-time end page.

In this aspect, when a purchase process for purchasing the electronic book is performed, the finally displayed page that is finally displayed by the user terminal in the electronic book is identified, and this finally displayed page is identified as an already-read middle page, as a first-time middle page, or as a first-time end page. The weight coefficient decreases in the order of the already-read middle page, the first-time middle page, and the first-time end page. In this manner, the weight coefficient of the already-read middle page that makes the user proceed to the purchase process even though being displayed for the second time or later is made the largest among those of these pages, and the weight coefficient of the first-time middle page that makes the user proceed to the purchase process even though being a page in the middle but is displayed for the first time is made the second largest among those of these pages, whereby it is possible to more accurately evaluate the magnitude of effect of each page in the electronic book on getting users interested.

According to one aspect of the present invention, an evaluation method includes a start page identification step of identifying, by an evaluation device, a start page that is initially displayed by a user terminal in an electronic book having a plurality of pages; a counting step of counting, by the evaluation device, a display amount of each page; a computing step of performing, by the evaluation device, computation for weighting the display amount counted at the counting step for each page, using a weight coefficient determined by coefficient determination means for, when another page of the electronic book is displayed subsequently to the start page identified as the starting point at the start page identification step, determining the weight coefficient for each page displayed so that the weight coefficient increases with more pages apart from the start page; and a calculating step of performing, by the evaluation device, computation for calculating the total amount of the display amount weighted at the computing step for each page.

With the evaluation method according to the one aspect of the present invention, the start page is identified first and the display amount of each page is counted. Next, the weight coefficient for each page is determined so that the weight coefficient increases with more pages apart from the start page, the display amount counted is weighted for each page, and the total amount of the display amount thus weighted is calculated for each page. In this manner, the display amount counted is weighted for each page by using the weight coefficient that increases with more pages apart from the start page. Accordingly, by weighting each page so that the weight coefficient increases with more pages apart from the start page instead of simply determining that the above-described degree of contribution of a page closer to the first page whose page views are more likely to be counted more is higher than that of a page further apart from the first page, it is possible to more accurately evaluate the magnitude of effect of each page in the electronic book on getting users interested.

According to one aspect of the present invention, an evaluation program causes a computer to implement a function of start page identification means for identifying a start page that is initially displayed by a user terminal in an electronic book having a plurality of pages; a function of coefficient determination means for, when another page of the electronic book is displayed subsequently to the start page identified as the starting point by the start page identification means, determining a weight coefficient for each page displayed so that the weight coefficient increases with more pages apart from the start page; a function of counting means for counting a display amount of each page; a function of computing means for performing computation for weighting the display amount counted by the counting means for each page, using the weight coefficient determined by the coefficient determination means; and a function of calculating means for performing computation for calculating the total amount of the display amount weighted by the computing means for each page.

With the evaluation program according to the one aspect of the present invention, the start page is identified first and the display amount of each page is counted. Next, the weight coefficient for each page is determined so that the weight coefficient increases with more pages apart from the start page, the display amount counted is weighted for each page, and the total amount of the display amount thus weighted is calculated for each page. In this manner, the display amount counted is weighted for each page by using the weight coefficient that increases with more pages apart from the start page. Accordingly, by weighting each page so that the weight coefficient increases with more pages apart from the start page instead of simply determining that the above-described degree of contribution of a page closer to the first page whose page views are more likely to be counted more is higher than that of a page further apart from the first page, it is possible to more accurately evaluate the magnitude of effect of each page in the electronic book on getting users interested.

According to one aspect of the present invention, a computer-readable recording medium records an evaluation program that causes a computer to implement a function of start page identification means for identifying a start page that is initially displayed by a user terminal in an electronic book having a plurality of pages; a function of coefficient determination means for, when another page of the electronic book is displayed subsequently to the start page identified as the starting point by the start page identification means, determining a weight coefficient for each page displayed so that the weight coefficient increases with more pages apart from the start page; a function of counting means for counting a display amount of each page; a function of computing means for performing computation for weighting the display amount counted by the counting means for each page, using the weight coefficient determined by the coefficient determination means; and a function of calculating means for performing computation for calculating the total amount of the display amount weighted by the computing means for each page.

With the computer-readable recording medium according to the one aspect of the present invention, the start page is identified first and the display amount of each page is counted. Next, the weight coefficient for each page is determined so that the weight coefficient increases with more pages apart from the start page, the display amount counted is weighted for each page, and the total amount of the display amount thus weighted is calculated for each page. In this manner, the display amount counted is weighted for each page by using the weight coefficient that increases with more pages apart from the start page. Accordingly, by weighting each page so that the weight coefficient increases with more pages apart from the start page instead of simply determining that the above-described degree of contribution of a page closer to the first page whose page views are more likely to be counted more is higher than that of a page further apart from the first page, it is possible to more accurately evaluate the magnitude of effect of each page in the electronic book on getting users interested.

### Advantageous Effects of Invention

According to the present invention, it is possible to provide an evaluation device, an evaluation method, and an evaluation program for further accurately evaluating the magnitude of effect of each page in an electronic book on getting users interested, and also a computer-readable recording medium recording the program.

### BRIEF DESCRIPTION OF DRAWINGS

FIG. 1 is a screen explanatory diagram illustrating one example of screen display of an electronic book.

FIG. 2 is a functional block diagram illustrating a functional structure of a book server.

FIG. 3 is a physical block diagram illustrating a physical structure of the book server.

FIG. 4 is an explanatory diagram illustrating one example of an operation history and an electronic book evaluation method.

FIG. 5 is an explanatory diagram illustrating another example of the operation history and the electronic book evaluation method.

FIG. 6 is an explanatory diagram illustrating still another example of the operation history and the electronic book evaluation method.

FIG. 7 is an explanatory diagram illustrating still another example of the operation history and the electronic book evaluation method.

FIG. 8 is a flowchart illustrating a flow of a series of processes performed by the book server.

FIG. 9 is a module block diagram illustrating a module structure of an evaluation program.

### DESCRIPTION OF EMBODIMENTS

Preferred embodiments of the present invention will be described below in detail with reference to the accompanying drawings. The same reference signs are given to the same or similar elements, and duplicate explanations are omitted.

1. Outline of Embodiments

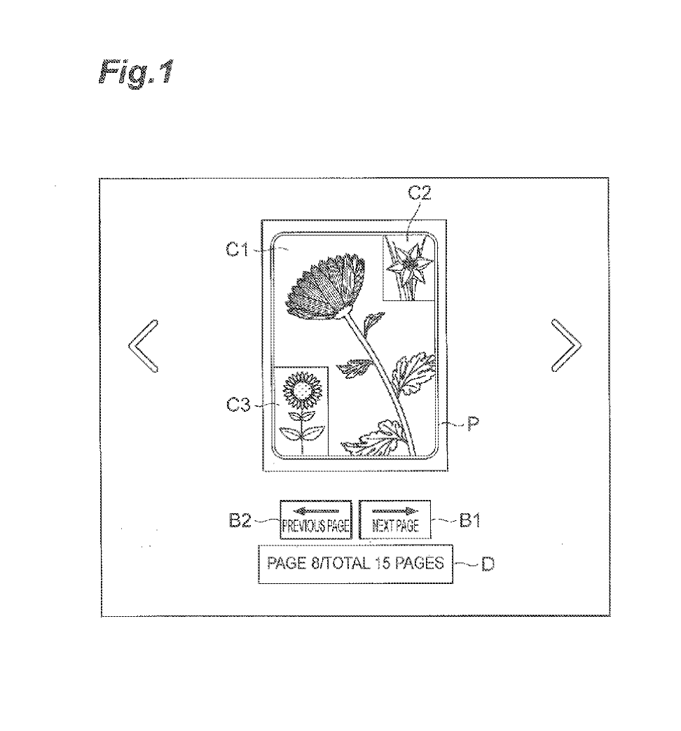

The outline of embodiments of a book server (evaluation device) according to the present invention will now be described with reference to FIG. 1. FIG. 1 is a screen explanatory diagram illustrating one example of screen display of an electronic book (also referred to as eBook (trademark)) to be evaluated by this book server. The electronic book is a collection of digital data that has functions of a digitized book configured to contain a plurality of pages P. FIG. 1 depicts one example in which page 8 out of 15 pages in total that can be browsed to consider whether to purchase the electronic book is displayed on a screen such as a display (of a user terminal described later).

What page out of the total pages is displayed is indicated in an indication field D. To display a page one page backward from page 8, a user could select (or click) a previous page button B1, and to display a page one page forward from page 8, the user could select (or click) a next page button B2. Some pages included in the electronic book may contain a plurality of contents C1 to C3.

The term “contents” herein means displayed objects that can be classified into a plurality of constituents (e.g., three contents C1 to C3) in one page (e.g., page P). The book server is a device that communicates with an electronic book having a plurality of pages, thereby identifying a page that gets a reading user reading the electronic book interested in the electronic book to evaluate the degree of contribution of the page.

2. Structure of Book Server

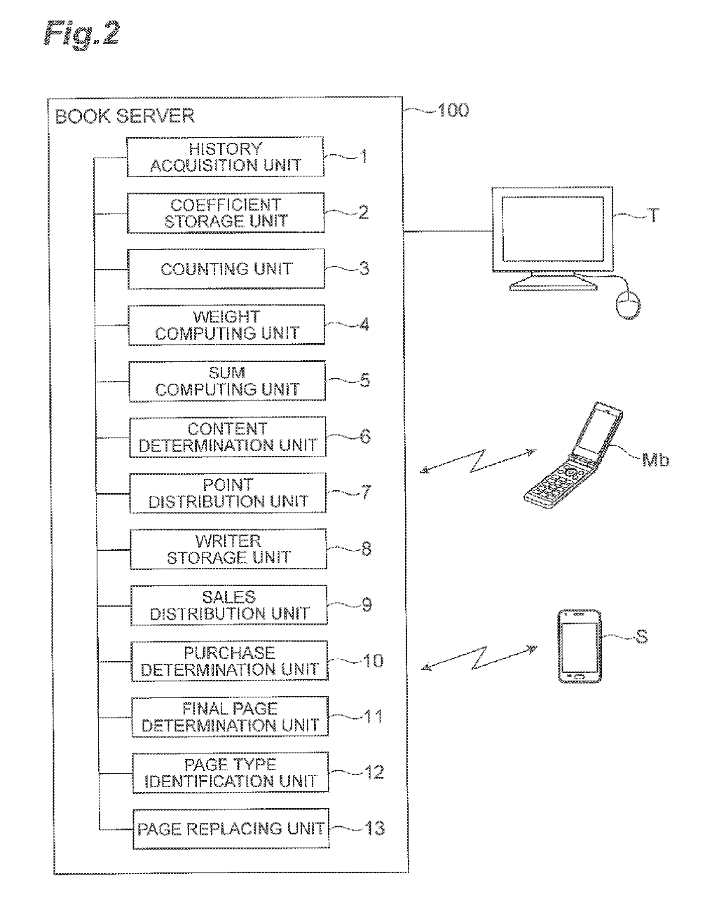

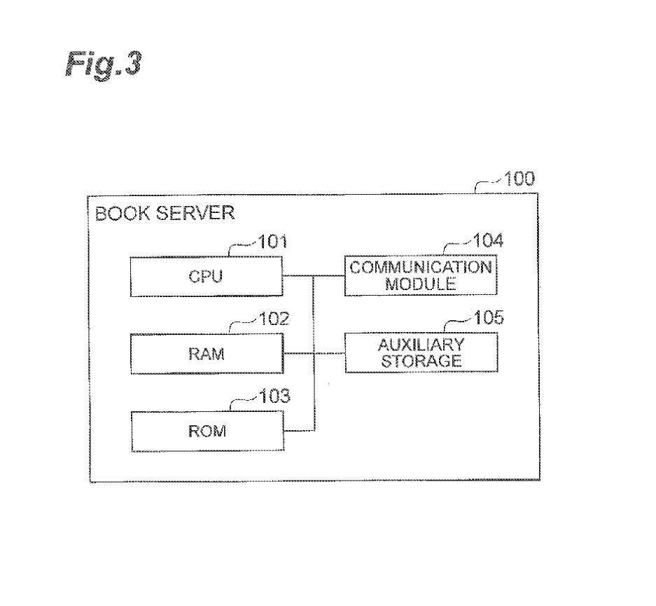

A structure of the book server will now be described with reference to FIGS. 2 and 3. FIG. 2 is a functional block diagram illustrating a functional structure of this book server 100, and FIG. 3 is a physical block diagram illustrating a physical structure of the book server 100. As depicted in FIG. 3, the book server 100 is structured as a computer server including, as major physical components, hardware such as a central processing unit (CPU) 101 that is an arithmetic processing unit, a random access memory (RAM) 102 and a read-only memory (ROM) 103 that are main storages, a communication module 104 for performing communication, and an auxiliary storage 105 such as a hard disk. Operation of these components implements functions of the book server 100.

As depicted in FIG. 2, the book server 100 also includes, as main functional components, a history acquisition unit 1 (start page identification means), a coefficient storage unit 2 (coefficient determination means), a counting unit 3 (counting means), a weight computing unit 4 (computing means), a sum computing unit 5 (calculating means), a content determination unit 6 (content determination means), a point distribution unit 7 (total amount distribution means), a writer storage unit 8 (writer storage means), a sales distribution unit 9 (sales distribution means), a purchase determination unit 10 (purchase determination means), a final page determination unit 11 (final identification unit), a page type identification unit 12 (page identification means), and a page replacing unit 13 (changing means).

The history acquisition unit 1 is a communication function part that performs wireless communication or wire communication with a user terminal such as a computer terminal T such as a PC, a mobile phone terminal Mb, or a smartphone S, thereby acquiring an operation history of an electronic book by a reading user using the user terminal. More specifically, the history acquisition unit 1 receives history information on an operation history of an electrical book by a reading user from a user terminal of the reading user and identifies (determines) a start page, a display direction, and a turned-back page.

The start page herein is a page that is initially displayed by the user terminal in the electronic book. The display direction is a direction indicating, when another page is displayed subsequently to the start page as a starting point, whether these pages are displayed in the direction in which page numbers increase or displayed in the direction in which page numbers decrease. The turned-back page is a page that is at a turned-back position when the display direction is changed. One example of the start page, the display direction, and the turned-back page will be described later.

The coefficient storage unit 2 is a computation-and-storage part that determines a weight coefficient for each page displayed based on the start page, the display direction, and the turned-back page identified by the history acquisition unit 1, and also stores therein weight coefficients thus determined in advance. For example, the coefficient storage unit 2 sets the weight coefficient for the start page to 1.0 (reference coefficient) and, when another page is displayed, determines the weight coefficient such that it increases by 0.1 (predetermined coefficient) as the page displayed proceeds one page in the same direction apart from the start page.

Also when the display direction is reversed at the turned-back page, the coefficient storage unit 2 determines the weight coefficient such that it increases by 0.1 (predetermined coefficient) as the page displayed proceeds one page in the direction apart from the turned-back page. Furthermore, the coefficient storage unit 2 may determine the weight coefficient such that it decreases in the order of an already-read middle page, a first-time middle page, and a first-time end page described later, and store therein weight coefficients thus determined in advance. One example of the weight coefficients will be described later.

The counting unit 3 is a count computing part that counts the display amount of each page in each display direction identified by the history acquisition unit 1. For example, the counting unit 3 counts the display amount of each page in the first display direction (herein as an example, the direction in which page numbers increase), counts the display amount of each page in the display direction (herein, the direction in which page numbers decrease) that is changed at the first turned-back page, and counts the display amount of each page in the direction (herein, the direction in which page numbers increase) that is changed at the second turned-back page.

The display amount of each page herein is an index indicating the degree of cumulative amount of state in which each page browsable by a reading user was being displayed, and examples thereof includes the number of display times and a period of display time. In the following explanations, it is assumed that the display amount of each page is the number of display times the page is read by the reading user, and the number of display times of each page displayed by the reading user is considered to equal to the number of reading times by the reading user.

When the display direction identified by the history acquisition unit 1 is changed, the counting unit 3 counts the display amount of the turned-back page with a predetermined amount added. For example, if the number of display times of each of the page one page before the turned-back page, the turned-back page, and the page one page after the turned-back page is one each, the number of display times of the turned-back page is counted with the number of predetermined times (e.g., once) so as to be counted as two times. One example of the number of display times will be described later.

The weight computing unit 4 is an arithmetic processing part that performs computation for weighting the display amount counted by the counting unit 3 for each page in each display direction, using weight coefficients stored in the coefficient storage unit 2. For example, if the weight coefficient for the first-time display of page 8 of the electronic book is 1.7, the reading point that is the number of reading times after being weighted is calculated as 1.7 points. One example of the number of display times thus weighted will be described later.

The sum computing unit 5 is a computation processing part that performs computation for calculating the sum of the display amount weighted by the weight computing unit 4 for each page. For example, if the weight coefficient for the first-time display of page 8 of the electronic book is 1.7, the weight coefficient for the second-time display thereof is 1.5, and the weight coefficient for the third-time display thereof is 0.8, the reading point that is the sum of the numbers of reading times after being weighted is calculated as (1.7+1.5+0.8=) 4.0 points. The sum computing unit 5 performs the above-described computation for each page for all reading users, and then performs computation for calculating the total points of reading points for each page for all reading users. One example of the total amount for each page will be described later.

The content determination unit 6 is a determination computing part that determines whether a content-containing page containing a plurality of contents exists among the above-described pages. For example, the content determination unit 6 determines that the page P at page 8 depicted in FIG. 1 is a content-containing page containing the contents C1 to C3.

The point distribution unit 7 is a computation processing part that, when the content determination unit 6 determines that a content-containing page exists, performs computation for distributing the total amount of the display amount of each page calculated by the sum computing unit 5 in accordance with occupying rates of the respective contents (in the content-containing page). For example, the point distribution unit 7 calculates that 4.0 points that is the total amount of reading points of the page P at page 8 depicted in FIG. 1 are distributed into 2.8 points for the content C1 in accordance with its occupying rate (area rate of 70%), 0.4 point for the content C2 in accordance with its occupying rate (area rate of 10%), and 0.8 point for the content C3 in accordance with its occupying rate (area rate of 20%).

The writer storage unit 8 is a storage part that stores therein each of a plurality of contents in content-containing pages and writer information on a writer of each of the contents in association with each other. For example, the writer storage unit 8 stores therein writer information on the content C1, a writer X who is the creator of the content C1 (including an author, a photographer, and a copyright holder, for example) in association with each other in advance.

The sales distribution unit 9 is a computation processing part that performs computation for distributing the sales amount of the electronic book input into the book server 100 in accordance with the amount of content created by each writer indicated by the writer information stored in the writer storage unit 8. For example, if the sales amount of the electronic book containing 15 pages in total is 1.2 million yen and the occupying rate of the amount of content created by the writer X in the electronic book is 6 pages' rate (corresponding to 40% of all pages), the sales distribution unit 9 calculates by computation that 480 thousands yen (corresponding to 40% of the sales amount) is a sales amount that should be distributed to the writer X.

The purchase determination unit 10 is a determination computing part that determines whether a purchase process for purchasing an electronic book that has been read by a reading user is performed by the reading user. For example, the purchase determination unit 10 stores therein a reading list of IDs of reading users who have displayed the electronic book in advance, and determines whether an ID of a user who purchases the electronic book is included in the reading list.

The final page determination unit 11 is an identification computing part that, when the purchase determination unit 10 determines that a purchase process of an electronic book is performed, identifies a finally displayed page that is finally displayed by a user terminal of a reading user who performs the purchase process. The final page determination unit 11 sequentially stores therein which page the finally displayed page finally displayed by the reading user is.

The page type identification unit 12 is a determination computing part that identifies the finally displayed page identified by the final page determination unit 11 as an already-read middle page, a first-time middle page, or a first-time end page. The already-read middle page is a page that is in the middle of displayable pages and is displayed for the second time or later for the reading user. The first-time middle page is a page that is in the middle of displayable pages and is displayed for the first time for the reading user. The first-time end page is a page that is the last page of displayable pages and is displayed for the first time for the reading user. The coefficient storage unit 2 may determines and stores therein the weight coefficients for the already-read middle page, the first-time middle page, and the first-time end page so as to make the weight coefficients larger in this order.

The page replacing unit 13 is a setting processing part that performs a shuffling process for changing a start page to be initially displayed by a user terminal to another page that is selected at random. The page replacing unit 13 can perform the shuffling process for changing the start page to another page selected at random when a predetermined condition described later is satisfied. The page replacing unit 13 can also change display order at random for another page displayed subsequently to the start page. The page replacing unit 13 performs the shuffling process only on pages that can be shuffled. The pages that can be shuffled herein mean pages of a photo book or a photograph collection without plot between the pages, for example, contained in an electronic book.

Examples of the predetermined condition herein include a case when a predetermined period of time (e.g., several hours) elapses from the previous shuffling process, a case when the number of reading times (page views) in one electronic book becomes a predetermined number or larger, a case when a page the number of reading times (page views) of which during a certain period (e.g., several days) is smaller than a predetermined number exists. The page replacing unit 13 can also perform a shuffling process for changing display order at random for another page to be displayed subsequently to the start page.

3. One Example of Operation History of Electronic Book and Electronic Book Evaluation Method

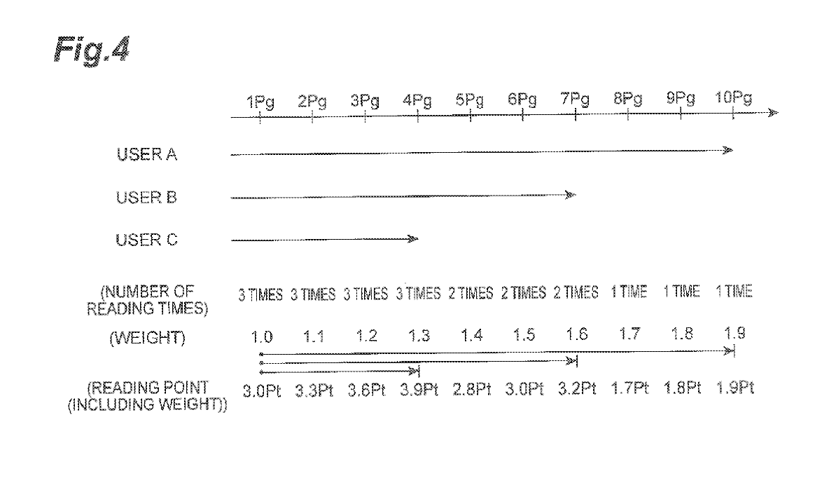

One example of an operation history of an electronic book by reading users and an electronic book evaluation method will be described below with reference to FIGS. 4 to 7. FIGS. 4 to 7 are exemplary diagrams each illustrating one example of an operation history and an electronic book evaluation method.

As depicted in FIG. 4, it is assumed that users A to C browsed an electronic book in which pages from page 1 to page 10 can be browsed. It is assumed herein that the user A displayed and read page 1 (start page) to page 10 in this order, the user B displayed and read page 1 (start page) to page 7 in this order, and the user C displayed and read page 1 (start page) to page 4 in this order.

In this case, the counting unit 3 detects that each of page 1 to page 4 was read three times in total, each of page 5 to page 7 was read two times in total, and each of page 8 to page 10 was read once in total.

Herein, the coefficient storage unit 2 determines the weight coefficient for each page displayed such that the weight coefficient starts with 1.0 (reference coefficient) for page 1 and increases by 0.1 as the page number increases by one, and the weight computing unit 4 weights the display amount of each page by performing multiplication of multiplying the display amount by the weight coefficient. The sum computing unit 5 performs computation for calculating the total amount of the display amount thus weighted for each page. For example, the sum computing unit 5 calculates for page 1 of the electronic book that the reading points being the total amount of the numbers of reading times after being weighted is (1.0+1.0+1.0=) 3.0 points because the weight coefficient for the first-time display is 1.0, the weight coefficient for the second-time display is 1.0, and the weight coefficient for the third-time display is 1.0.

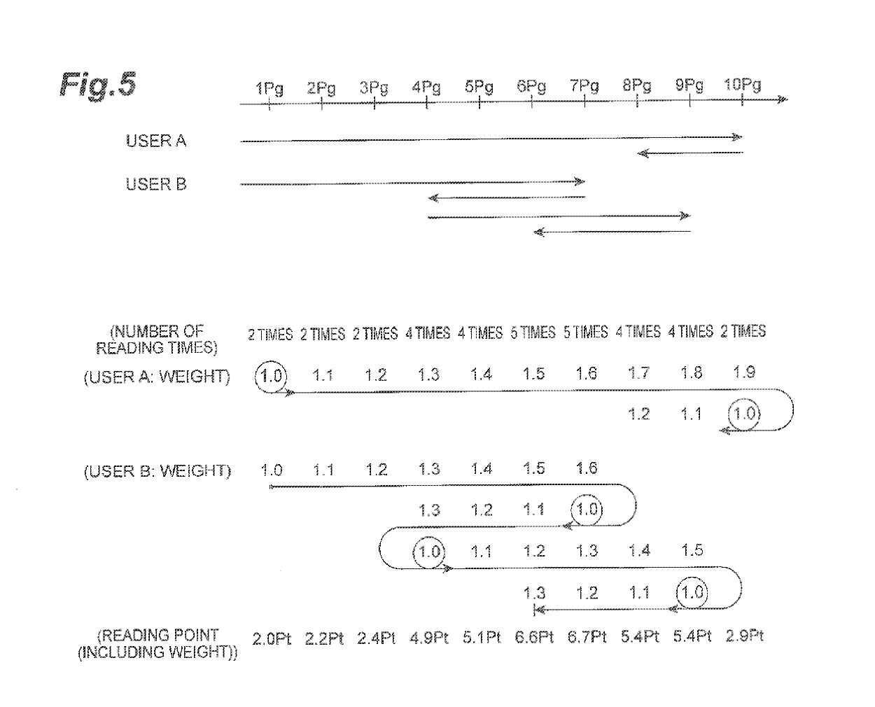

Next, it is assumed as depicted in FIG. 5 that users A and B browsed an electronic book in which pages from page 1 to page 10 can be browsed. It is assumed herein that the user A displayed and read page 1 (start page) to page 10 in this order, and then changed the display direction at page 10 as a turned-back page and displayed and read page 10 to page 8 in this order. It is also assumed that the user B displayed and read page 1 (start page) to page 7 in this order, then changed the display direction at page 7 as a turned-back page and displayed and read page 7 to page 4 in this order, then changed the display direction at page 4 as a turned-back page and displayed and read page 4 to page 9 in this order, and then changed the display direction at page 9 as a turned-back page and displayed and read page 9 to page 6 in this order.

In this case, the counting unit 3 detects that each of pages 1 to 3 and 10 was read two times in total, each of pages 4 to 5 and 8 to 9 was read four times, and each of pages 6 to 7 was read five times.

Herein, the coefficient storage unit 2 determines the weight coefficient for each page displayed for the user A such that the weight coefficient starts with 1.0 (reference coefficient) for page 1 and increases by 0.1 as the page number increases by one, and also determines the weight coefficient such that it reaches 1.9 for page 10, then starts with 1.0 (reference coefficient) for page 10 as the turned-back page, and increases by 0.1 as the page number decreases by one.

In addition, the coefficient storage unit 2 determines the weight coefficient for each page displayed for the user B such that the weight coefficient starts with 1.0 (reference coefficient) for page 1 and increases by 0.1 as the page number increases by one, and determines the weight coefficient such that it reaches 1.6 for page 7, then starts with 1.0 (reference coefficient) for page 7 as the turned-back page, and increases by 0.1 as the page number decreases by one. The coefficient storage unit 2 also determines the weight coefficient such that it reaches 1.3 for page 4, then starts with 1.0 (reference coefficient) for page 4 as the turned-back page, and increases by 0.1 as the page number increases by one. The coefficient storage unit 2 also determines the weight coefficient such that it reaches 1.5 for page 9, then starts with 1.0 (reference coefficient) for page 9 as the turned-back page, and increases by 0.1 as the page number decreases by one.

The weight computing unit 4 weights the display amount of each page by performing multiplication of multiplying the display amount by the weight coefficient. The sum computing unit 5 performs computation for calculating the total amount of the display amount thus weighted for each page. For example, the sum computing unit 5 calculates for page 7 of the electronic book that the reading points being the total amount of the numbers of reading times after being weighted is (1.6+1.6+1.0+1.3+1.2=) 6.7 points because the weight coefficient for the first-time display by the user A is 1.6, the weight coefficient for the first-time display by the user B is 1.6, the weight coefficient for the second-time display by the user B is 1.0, the weight coefficient for the third-time display by the user B is 1.3, and the weight coefficient for the fourth-time display by the user B is 1.2.

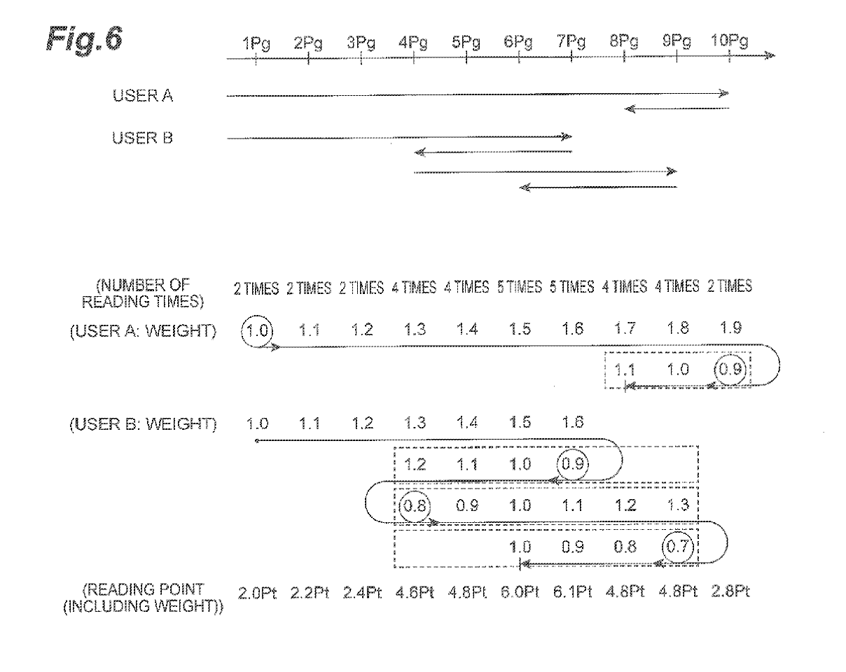

Next, it is assumed as depicted in FIG. 6 that users A and B browsed an electronic book in which pages from page 1 to page 10 can be browsed. It is assumed herein that the user A displayed and read page 1 (start page) to page 10 in this order, and then changed the display direction at page 10 as a turned-back page and displayed and read page 10 to page 8 in this order. It is also assumed that the user B displayed and read page 1 (start page) to page 7 in this order, then changed the display direction at page 7 as a turned-back page and displayed and read page 7 to page 4 in this order, then changed the display direction at page 4 as a turned-back page and displayed and read page 4 to page 9 in this order, and then changed the display direction at page 9 as a turned-back page and displayed and read page 9 to page 6 in this order.

In this case, the counting unit 3 detects that each of pages 1 to 3 and 10 was read two times in total, each of pages 4 to 5 and 8 to 9 was read four times, and each of pages 6 to 7 was read five times.

Herein, the coefficient storage unit 2 determines the weight coefficient for each page displayed for the user A such that the weight coefficient starts with 1.0 (reference coefficient) for page 1 and increases by 0.1 as the page number increases by one, and also determines the weight coefficient such that it reaches 1.9 for page 10, then starts with 0.9 (coefficient smaller than the above-described reference factor by a predetermined coefficient) for page 10 as the turned-back page, and increases by 0.1 as the page number decreases by one. The reason why the coefficient for page 10 as the turned-back page is set smaller than the above-described reference coefficient by the predetermined coefficient is because the page is considered to contribute less because of being already read.

In addition, the coefficient storage unit 2 determines the weight coefficient for each page displayed for the user B such that the weight coefficient starts with 1.0 (reference coefficient) for page 1 and increases by 0.1 as the page number increases by one, and determines the weight coefficient such that it reaches 1.6 for page 7, then starts with 0.9 (coefficient smaller than the above-described reference coefficient by the predetermined coefficient) for page 7 as the turned-back page, and increases by 0.1 as the page number decreases by one. The coefficient storage unit 2 also determines the weight coefficient such that it reaches 1.2 for page 4, then starts with 0.8 (coefficient further decreased by the predetermined coefficient) for page 4 as the turned-back page, and increases by 0.1 as the page number increases by one. The coefficient storage unit 2 also determines the weight coefficient such that it reaches 1.3 for page 9, then starts with 0.7 (coefficient further decreased by the predetermined coefficient) for page 9 as the turned-back page, and increases by 0.1 as the page number decreases by one. The reason why the coefficients for pages 7, 4, and 9 as the turned-back page are determined to be coefficient decreased by the predetermined coefficient is because the pages are considered to contribute less because of being already read.

The weight computing unit 4 weights the display amount of each page by performing multiplication of multiplying the display amount by the weight coefficient. The sum computing unit 5 performs computation for calculating the total amount of the display amount thus weighted for each page. For example, the sum computing unit 5 calculates for page 7 of the electronic book that the reading points being the total amount of the numbers of reading times after being weighted is (1.6+1.6+0.9+1.1+0.9=) 6.1 points because the weight coefficient for the first-time display by the user A is 1.6, the weight coefficient for the first-time display by the user B is 1.6, the weight coefficient for the second-time display by the user B is 0.9, the weight coefficient for the third-time display by the user B is 1.1, and the weight coefficient for the fourth-time display by the user B is 0.9.

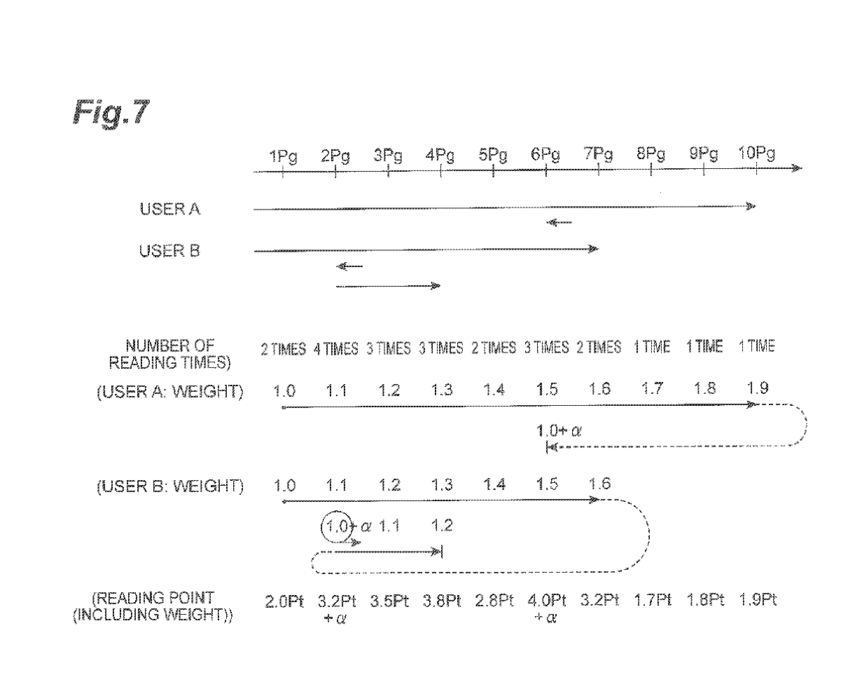

Next, it is assumed as depicted in FIG. 7 that users A and B browsed an electronic book in which pages from page 1 to page 10 can be browsed. It is assumed herein that the user A displayed and read page 1 (start page) to page 10 in this order and then displayed and read page 6 by designation by the user A. It is also assumed that the user B displayed and read page 1 (start page) to page 7 in this order, then displayed and read page 2 by designation by the user B, and then displayed and read page 3 to page 4 in this order.

In this case, the counting unit 3 detects that each of pages 1, 5, and 7 was read two times in total, page 2 was read four times in total, each of pages 3 to 4 and 6 was read three times in total, and each of pages 8 to 10 was read three times in total.

Herein, the coefficient storage unit 2 determines the weight coefficient for each page displayed for the user A such that the weight coefficient starts with 1.0 for page 1 and increases by 0.1 as the page number increases by one, and also determines the weight coefficient such that it reaches 1.9 for page 10, then is set to 1.0+a for the second-time page 6. This a may be a variable value or may be a specifically fixed value such as 0.5.

In addition, the coefficient storage unit 2 determines the weight coefficient for each page displayed for the user B such that the weight coefficient starts with 1.0 for page 1 and increases by 0.1 as the page number increases by one, and also determines the weight coefficient such that it reaches 1.6 for page 7, then is set to 1.0+a for the second-time page 4, 1.1 for the second-time page 3, and 1.2 for the second-time page 4.

The weight computing unit 4 weights the display amount of each page by performing multiplication of multiplying the display amount by the weight coefficient. The sum computing unit 5 performs computation for calculating the total amount of the display amount thus weighted for each page. For example, the sum computing unit 5 calculates for page 6 of the electronic book that the reading points being the total amount of the numbers of reading times after being weighted is (1.5+1.0+α+1.5=) 4.0+α points because the weight coefficient for the first-time display by the user A is 1.5, the weight coefficient for the second-time display by the user A is 1.0+α, and the weight coefficient for the first-time display by the user B is 1.5.

If the display of page 6 by designation by the user A was performed by clicking a table of contents or a link in the electronic book, it is estimated that the user A had a “desire” to browse again this already-read page, and accordingly the coefficient storage unit 2 can set a to a relatively large value. In contrast, if the display of page 6 by designation by the user A was performed by page designation at random not by clicking the table of contents or the link in the electronic book, it is estimated that the user A did not have a “desire” to browse an unread page, and accordingly the coefficient storage unit 2 can set a to a relatively small value.

4. Flow of Series of Processes Performed by Book Server

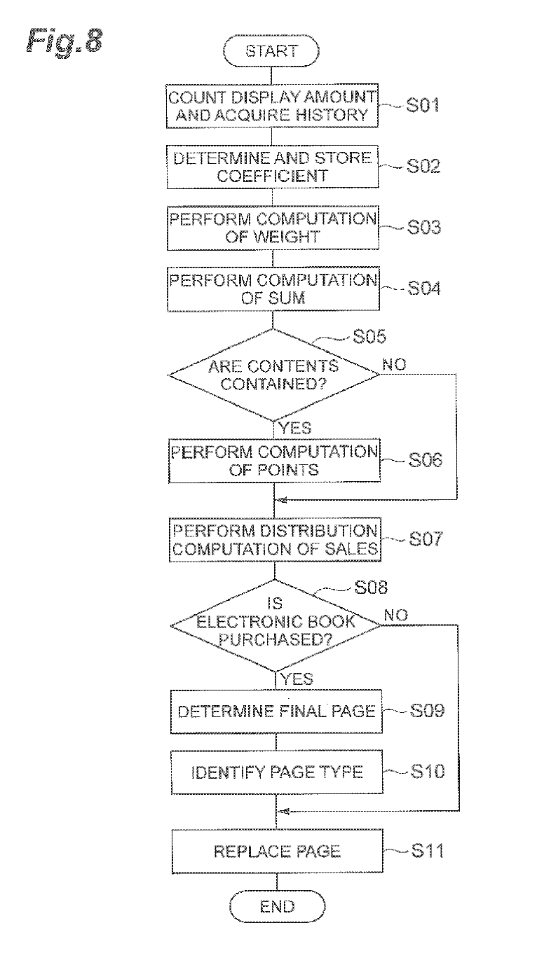

One example of a flow of a series of processes (evaluation method) performed by the book server 100 will be described below with reference with FIG. 8. FIG. 8 is a flowchart illustrating the flow of a series of processes performed by the book server 100.

The history acquisition unit 1 and the counting unit 3, by performing wireless communication or wire communication with a user terminal such as a computer terminal T such as a PC, a mobile phone terminal Mb, or a smartphone S, acquires an operation history of an electronic book by a reading user using the user terminal and also counts the display amount of each page (step S01, start page identification step and counting step). More specifically, the history acquisition unit 1 receives history information on an operation history of an electrical book by a reading user from a user terminal of the reading user and identifies a start page, a display direction, and a turned-back page, and the counting unit 3 counts the display amount of each page in each display direction identified by the history acquisition unit 1.

Next, the coefficient storage unit 2 determines a weight coefficient for each page displayed based on the start page, the display direction, and the turned-back page identified by the history acquisition unit 1, and also stores therein weight coefficients thus determined in advance (step S02, computing step). The weight computing unit 4 performs computation for weighting the display amount counted by the counting unit 3 for each page in each display direction, using the weight coefficients stored in the coefficient storage unit 2 (step S03, computing step).

Next, the sum computing unit 5 performs computation for calculating the sum of the display amount weighted by the weight computing unit 4 for each page (step S04, calculating step). The content determination unit 6 determines whether a content-containing page containing a plurality of contents exists among the above-described pages (step S05, content determination step). If the content determination unit 6 does not determine that a content-containing page exists, the flow proceeds to step S07 described later. If the content determination unit 6 determines that a content-containing page exist, the point distribution unit 7 performs computation for distributing the total amount of the display amount of each page calculated by the sum computing unit 5 in accordance with occupying rates of the respective contents (in the content-containing page) (step S06, point distribution step).

Next, at step S07, the sales distribution unit 9 performs computation for distributing the sales amount (total points considered for all users) corresponding to the total amount of the display amount calculated by the sum computing unit 5 for each page to each writer indicated by the writer information stored in the writer storage unit 8 (sales distribution step).

Next, the purchase determination unit 10 determines whether a purchase process for purchasing an electronic book that has been read by a reading user is performed by the reading user (step S08, purchase determination step). If the purchase determination unit 10 does not determine that a purchase process of the electronic book is performed, the flow proceeds to step Si 1 described later. If the purchase determination unit 10 determines that a purchase process on the electronic book is performed, the final page determination unit 11 identifies a finally displayed page that is finally displayed by a user terminal of a reading user who performs the purchase process (step S09, final page determination step).

Next, the page type identification unit 12 identifies the finally displayed page identified by the final page determination unit 11 as an already-read middle page, a first-time middle page, or a first-time end page (step S10, page type identification step). Herein, the coefficient storage unit 2 may determine and store therein the weight coefficient such that it decreases in the order of an already-read middle page, a first-time middle page, and a first-time end page.

Next, at step S11, the page replacing unit 13 performs a shuffling process for changing a start page to be initially displayed by a user terminal to another page that is selected at random (page replacing step). Then, the series of processes end.

5. Module Structure of Evaluation Program

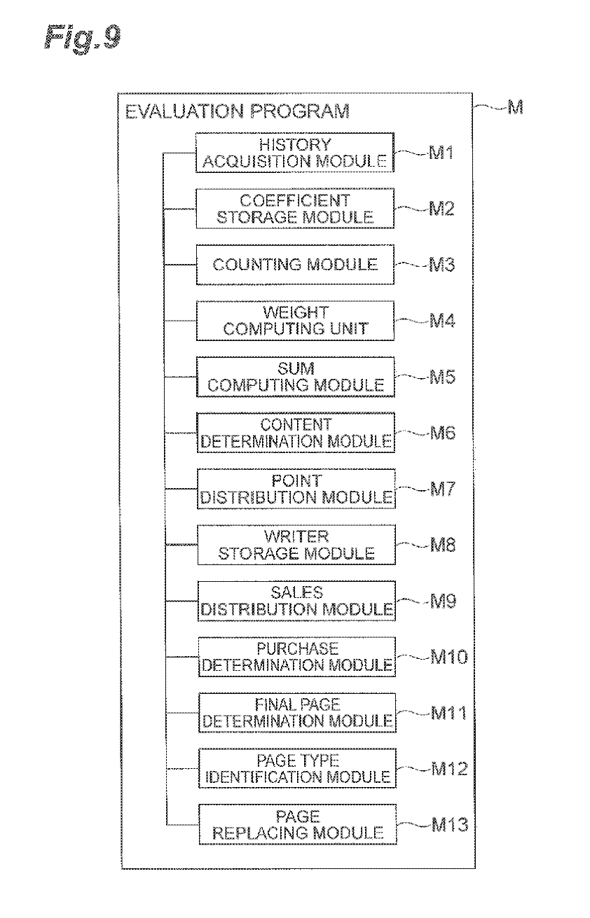

A module structure of an evaluation program for causing a computer to function as the book server 100 will be described below with reference to FIG. 9. FIG. 9 is a module block diagram illustrating the module structure of this evaluation program M for causing the computer to function as the book server 100.

As depicted in FIG. 9, the evaluation program M is configured to include a history acquisition module M1, a coefficient storage module M2, a counting module M3, a weight computing module M4, a sum computing module M5, a content determination module M6, a point distribution module M7, a writer storage module M8, a sales distribution module M9, a purchase determination module M10, a final page determination module M11, a page type identification module M12, and a page replacing module M13.

The history acquisition module M1 is a part that controls a function of causing the computer to perform a computation process of various information in an integrated manner. Executing the history acquisition module M1 implements functions of the above-described book server 100. Executing the history acquisition module M1 also implements functions of the history acquisition unit 1.

Furthermore, functions that are implemented by executing the coefficient storage module M2, the counting module M3, the weight computing module M4, the sum computing module M5, the content determination module M6, the point distribution module M7, the writer storage module M8, the sales distribution module M9, the purchase determination module M10, the final page determination module M11, the page type identification module M12, and the page replacing module M13 are respectively the same as the functions of the coefficient storage unit 2, the counting unit 3, the weight computing unit 4, the sum computing unit 5, the content determination unit 6, the point distribution unit 7, the writer storage unit 8, the sales distribution unit 9, the purchase determination unit 10, the final page determination unit 11, the page type identification unit 12, and the page replacing unit 13.

The evaluation program M is provided in a manner permanently recorded in a storage medium such as a CD-ROM or a DVD ROM or a semiconductor memory. The evaluation program M may be provided as a computer data signal superimposed on a carrier wave via a communication network.

6. Functions and Effects of the Present Invention

With the book server 100, the start page and the display direction are identified, and the display amount (e.g., the number of display times or the period of display time) for each page in each display direction is counted. The weight coefficient for each page is determined such that the weight coefficient increases with more pages apart from the start page, and the display amount counted in each display direction is weighted for each page in each display direction. The total amount of the display amount thus weighted is calculated for each page.

In this manner, with the weight coefficient that increases with more pages apart from the start page, the display amount counted in each display direction is weighted for each page in each display direction. Accordingly, by weighting each page so that the weight coefficient increases with more pages apart from the start page instead of simply determining that the above-described degree of contribution of a page closer to the first page whose page views are more likely to be counted more is higher than that of a page further apart from the first page, it is possible to more accurately evaluate the magnitude of effect of each page in the electronic book on getting users interested (the degree of contribution to the success in getting the users interested or causing the users to purchase the electronic book).

With the book server 100, a turned-back page at a turned-back position when the display direction is changed is identified, and the weight coefficient for each page displayed is determined based on the start page, the display direction, and the turned-back page. Accordingly, even when the display direction is changed, a coefficient determined based on the turned-back page is used, whereby it is possible to more accurately evaluate the magnitude of effect (degree of contribution) for each page in the electronic book on getting users interested.

With the book server 100, it is possible to count the display amount of the turned-back page with a predetermined amount added when the display direction is changed.

With the book server 100, when it is determined that a content-containing page exists, computation for distributing the total amount of the display amount of each page in accordance with occupying rates of the respective contents in the content-containing page is performed. This makes it possible to more accurately evaluate the magnitude of effect (degree of contribution) of the respective contents on getting users interested.

With the book server 100, computation for distributing the sales figures of the electronic book in accordance with the amount of content created by each writer indicated by the writer information is performed. This makes it possible to distribute the sales figures to the respective writers of the contents in accordance with the amount of content created.

With the book server 100, when a predetermined condition is satisfied, it is possible to change the start page to be initially displayed by the user terminal to a page selected at random (shuffling process). Consequently, by setting a state in which opportunities to be read by reading users are extremely uneven as a state in which the predetermined condition is satisfied, the shuffling process is allowed to eliminate the unevenness, thereby making it possible to more accurately evaluate the magnitude of effect (degree of contribution) of the respective contents on getting users interested.

With the book server 100, it is possible to change display order at random for another page displayed subsequently to the start page. Consequently, when opportunities to be read by reading users are extremely uneven, the shuffling process is allowed to eliminate the unevenness, thereby making it possible to more accurately evaluate the magnitude of effect (degree of contribution) of the respective contents on getting users interested.

With the book server 100, when it is determined that a purchase process for the electronic book is performed, a finally displayed page is identified, and this finally displayed page is identified as an already-read middle page, as a first-time middle page, or as a first-time end page. The weight coefficient may decrease in the order of the already-read middle page, the first-time middle page, and the first-time end page.

In this manner, the weight coefficient of the already-read middle page that makes the user proceed to the purchase process even though being displayed for the second time or later (i.e., the degree of contribution is very high even though the page had been already read) is made the largest among those of these pages, and the weight coefficient of the first-time middle page that makes the user proceed to the purchase process even though being a page in the middle but is displayed for the first time (i.e., the degree of contribution is lower than that of the case of being already read because the page is read for the first time and thus the user is more likely to proceed to a purchase process) is made the second largest among those of these pages, whereby it is possible to more accurately evaluate the magnitude of effect (degree of contribution) of each page in the electronic book on getting users interested.

7. Modifications

The embodiments according to the present invention have been described with a structure in which the book server 100 evaluates an electronic book that is displayed page by page as depicted in FIG. 1, but the display mode of the electronic book is not limited to this and, for example, the structure may be one in which the book server 100 evaluates an electronic book that displays a double-page spread for two pages to be considered as one page.

The embodiments according to the present invention have been described with a structure in which the flow of the series of processes depicted in FIG. 8 is performed, but the flow of the series of processes is not limited to this and, for example, the structure may be one in which the process at step S07 is moved to before step S05, or may be one in which the process at step S07 is moved to after step S11.

### INDUSTRIAL APPLICABILITY

According to the present invention, it is more accurately evaluate the magnitude of effect of each page in an electronic book on getting users interested.

### REFERENCE SIGNS LIST

1 . . . history acquisition unit, 2 . . . coefficient storage unit, 3 . . . counting unit, 4 . . . weight computing unit, 5 . . . sum computing unit, 6 . . . content determination unit, 7 . . . point distribution unit, 8 . . . writer storage unit, 9 . . . sales distribution unit, 10 . . . purchase determination unit, 11 . . . final page determination unit, 12 . . . page type identification unit, 13 . . . page replacing unit, 100 . . . book server, B1 . . . previous page button, B2 . . . next page button, C1 to C3 . . . contents, D . . . indication field, Mb . . . mobile phone terminal, M . . . evaluation program, M1 . . . history acquisition module, M2 . . . coefficient storage module, M3 . . . counting module, M4 . . . weight computing module, M5 . . . sum computing module, M6 . . . content determination module, M7 . . . point distribution module, M8 . . . writer storage module, M9 . . . sales distribution module, M10 . . . purchase determination module, M11 . . . final page determination module, M12 . . . page type identification module, M13 . . . page replacing module, P . . . page, S . . . smartphone, T . . . computer terminal

1. An evaluation device comprising:
start page identification unit configured to identify a start page that is initially displayed by a user terminal in an electronic book having a plurality of pages;
coefficient determination unit configured to, when another page of the electronic book is displayed subsequently to the start page identified as a starting point by the start page identification unit, determine a weight coefficient for each page displayed so that the weight coefficient increases with more pages apart from the start page;
counting unit configured to count a display amount of each page;
computing unit configured to perform computation for weighting the display amount counted by the counting unit for each page, using the weight coefficient determined by the coefficient determination unit; and
calculating unit configured to perform computation for calculating a total amount of the display amount weighted by the computing unit for each page.

2. The evaluation device according to claim 1, wherein the display amount is number of display times each page is displayed by the user terminal.

3. The evaluation device according to claim 1, wherein the display amount is a period of display time during which each page is displayed by the user terminal.

4. The evaluation device according to claim 1, wherein
the start page identification unit identifies the start page and, when another page in the electronic book is displayed subsequently to the start page as the starting point, identifies a display direction indicating whether these pages are displayed in the direction in which page numbers increase or displayed in the direction in which page numbers decrease;
the coefficient determination unit determines the weight coefficient for each page in each display direction identified by the start page identification unit;
the counting unit counts the display amount for each page in each display direction; and
the computing unit weights the display amount counted by the counting unit for each page in each display direction, using the weight coefficient determined by the coefficient determination unit.

5. The evaluation device according to claim 4, wherein
the start page identification unit identifies a turned-back page at a turned-back position when the display direction is changed, and
the coefficient determination unit determines the weight coefficient for each page displayed based on the start page, the display direction, and the turned-back page identified by the start page identification unit.

6. The evaluation device according to claim 5, wherein the counting unit counts the display amount of the turned-back page with a predetermined amount added when the display direction is changed.

7. The evaluation device according to claim 1, further comprising:
content determination unit configured to determine whether a content-containing page containing a plurality of contents exists among the pages; and
total amount distribution unit configured to, when the content determination unit determines that the content-containing page exists, perform computation for distributing the total amount of the display amount of each page calculated by the calculating unit in accordance with occupying rates of the respective contents in the content-containing page.

8. The evaluation device according to claim 7, further comprising:
writer storage unit configured to store the respective contents and writer information on respective writers of the contents in association with each other; and
sales distribution unit configured to perform computation for distributing sales figures of the electronic book in accordance with amounts of contents created by the respective writers that are indicated by the writer information stored in the writer storage unit.

9. The evaluation device according to claim 1, further comprising changing unit configured to change the start page to be initially displayed by the user terminal to a page selected at random.

10. The evaluation device according to claim 9, wherein the changing unit changes the start page to be initially displayed by the user terminal to a page selected at random when a predetermined condition is satisfied.

11. The evaluation device according to claim 9, wherein the changing unit changes display order at random for another page to be displayed subsequently to the start page.

12. The evaluation device according to claim 1, further comprising:
final identification unit configured to identify a finally displayed page that is finally displayed by the user terminal in the electronic book when a purchase process for purchasing the electronic book is performed; and
page identification unit configured to identify the finally displayed page identified by the final identification unit as an already-read middle page that is a page in the middle of displayable pages and is displayed for the second time or later for the user, as a first-time middle page that is a page in the middle of displayable pages and is displayed for the first time for the user, or as a first-time end page that is the last page of displayable pages and is displayed for the first time for the user, wherein
the weight coefficient determined by the coefficient determination unit decreases in the order of the already-read middle page, the first-time middle page, and the first-time end page.

13. An evaluation method comprising:
a start page identification step of identifying, by an evaluation device, a start page that is initially displayed by a user terminal in an electronic book having a plurality of pages;
a counting step of counting, by the evaluation device, a display amount of each page;
a computing step of performing, by the evaluation device, computation for weighting the display amount counted at the counting step for each page, using a weight coefficient determined by coefficient determination unit configured to, when another page of the electronic book is displayed subsequently to the start page identified as the starting point at the start page identification step, determine the weight coefficient for each page displayed so that the weight coefficient increases with more pages apart from the start page; and
a calculating step of performing, by the evaluation device, computation for calculating a total amount of the display amount weighted at the computing step for each page.

14. (canceled)

15. A computer-readable recording medium recording an evaluation program that causes a computer to implement:
a start page identification function of identifying a start page that is initially displayed by a user terminal in an electronic book having a plurality of pages;
a coefficient determination function of, when another page of the electronic book is displayed subsequently to the start page identified as the starting point by the start page identification function, determining a weight coefficient for each page displayed so that the weight coefficient increases with more pages apart from the start page;
a counting function of counting a display amount of each page;
a computing function of performing computation for weighting the display amount counted by the counting function for each page, using the weight coefficient determined by the coefficient determination function; and
a calculating function of performing computation for calculating a total amount of the display amount weighted by the computing function for each page.
